(19) United States
(12) Patent Application Publication
(10) Pub. No.: US 2014/0361729 A1
(43) Pub. Date: Dec. 11, 2014

(54) Devices, Systems and Methods for Mining Equipment

(71) Applicant: EnerSys Delaware Inc., Reading, PA (US)

(72) Inventor: William F. Cooper, Washington, PA (US)

(21) Appl. No.: 13/910,157

(22) Filed: Jun. 5, 2013

(51) Int. Cl. H02J 7/00

(52) U.S. Cl. CPC H02J 7/0042
USPC 320/107; 320/137

(57) ABSTRACT

A charging device adapter includes an adapter receptacle that is positioned proximate a charging device. The charging device is configured to charge a rechargeable device and includes multiple charger output plugs that are conductively coupled to the charger. The adapter receptacle is configured to receive one of the charger output plugs when the rechargeable device includes a quantity of charging receptacles that is less than a quantity of the charger output plugs.

### FIELD OF THE INVENTION

The present invention relates to electrical connectors and, more particularly, to charging rechargeable mining equipment.

### BACKGROUND

Electrically powered equipment may be used for a variety of purposes and in many different environments. For example, industries that use equipment in confined spaces and/or in the presence of potentially combustible vapors and/or materials may rely on electrically powered equipment. Examples of such industries and/or environments may include those related to mining operations, among others.

Since the electrically powered equipment may be mobile in use and operation, such equipment may include on-board power supplies and/or energy storage devices, such as, batteries. In such circumstances, battery charging equipment may be used to recharge the batteries between usage periods of the equipment. However, different electrically powered equipment may have different battery and/or charging configurations. As such, different types and/or configurations of battery charging equipment may be used to charge the different electrically powered equipment.

For example, brief reference is made to FIGS. 1a and 1b, which are block diagrams illustrating conventional charging circuits and rechargeable equipment having two batteries and one battery, respectively. Referring to FIG. 1a, a charging circuit 10A that is configured to charge batteries 1 and 2 24-1, 24-2, may include charger output plugs 30-1 and 30-2 that are configured to be received by charging receptacles 22-1 and 22-2 on the rechargeable equipment 20A. The charger output plugs 30-1 and 30-2 may be conductively coupled to the charging circuit 10A via one or more cables and/or wires 12-1 and 12-2, respectively. Similarly, referring to FIG. 1b, a charging circuit 10B is configured to charge battery 24 may include a charger output plug 30 that is configured to be received by a charging receptacle 22 on the rechargeable equipment 20B. The charger output plug 30 may be conductively coupled to the charging circuit 10B via one or more cables and/or wires 12. As provided above, users having both rechargeable equipment 20A and rechargeable equipment 20B may also require multiple different types of charging circuits 10A and 10B or devices.

### SUMMARY

Embodiments described herein may be directed to a charging device adapter that includes an adapter receptacle that is positioned proximate a charging device that is configured to charge a rechargeable device. The charging device may include multiple charger output plugs that are conductively coupled to a charging circuit. The adapter receptacle is configured to receive one of the charger output plugs when the rechargeable device includes a quantity of charging receptacles that is less than a quantity of the charger output plugs.

Some embodiments provide that the charger device adapter includes an adapter housing that is configured to be mounted to the charging device and that is configured to receive and support the adapter receptacle.

In some embodiments, the charger output plugs include a first charger output plug and a second charger output plug, the quantity charging receptacles on the rechargeable device is one charging receptacle, the one charging receptacle is configured to receive the first charger output plug, and the adapter receptacle is configured to receive the second charger output plug.

Some embodiments provide that the adapter receptacle includes multiple electrical contacts arranged in a non-conductive housing. The non-conductive housing may include a first side that is configured to receive and/or engage the one of charger output plugs and a second side that is opposite the first side. The adapter receptacle may further include an electrically conductive jumper that is connected to a first electrical contact and a second electrical contact of the electrical contacts to cause an electrical short circuit across the first electrical contact and the second electrical contact. In some embodiments, the electrically conductive jumper is a first electrically conductive jumper and the adapter receptacle further includes a second electrically conductive jumper that is connected to a third electrical contact and a fourth electrical contact of the electrical contacts to cause an electrical short circuit across the third electrical contact and the fourth electrical contact.

In some embodiments, the first electrical contact is configured to engage a first plug contact corresponding to a positive direct current (DC) charge output of the charging device and the second electrical contact is configured to engage a second plug contact corresponding to a negative direct current (DC) charge output of the charging device. Some embodiments provide that the third electrical contact is configured to engage a third plug contact corresponding to an electrical ground and the fourth electrical contact is configured to engage a fourth plug contact corresponding to an electrical ground check of the charging device.

Some embodiments provide that the electrically conductive jumper is connected to the first electrical contact and the second electrical contact on the second side of the non-conductive housing.

In some embodiments, the rechargeable device comprises mining equipment.

Some embodiments provide that the adapter receptacle is configured to operate at voltages around 200 volts DC (direct current) and the electrical contacts are configured to carry about 350 amperes DC.

Some embodiments of the present invention are directed to configurable charging systems. Such systems may include a charging circuit that is configured to provide an electrical charging current to a rechargeable mining device, a first charger output plug that is conductively coupled to the charging circuit via a first multiple conductor cable, and a second charger output plug that is conductively coupled to the charging circuit via a second multiple conductor cable. Systems may further include an adapter receptacle that is configured to receive the second charger output plug when the rechargeable mining device includes a single charging receptacle that is configured to receive the first charger output plug. In some embodiments, when the rechargeable mining device includes two charging receptacles, the two charging receptacles are configured to receive the first charger output plug and the second charger output plug.

Some embodiments provide that the adapter receptacle includes multiple electrical contacts arranged in a non-conductive housing, the non-conductive housing including a first side that is configured to receive the second charger output plug and a second side that is opposite the first side. The adapter receptacle may include an electrically conductive jumper that is connected to a first electrical contact and a second electrical contact of the electrical contacts to cause an electrical short circuit across the first electrical contact and the second electrical contact.

In some embodiments, the electrically conductive jumper includes a first electrically conductive jumper and the adapter receptacle includes a second electrically conductive jumper that is connected to a third electrical contact and a fourth electrical contact of the electrical contacts to cause an electrical short circuit across the third electrical contact and the fourth electrical contact. In some embodiments, the first electrical contact is configured to engage a first plug contact corresponding to a positive direct current (DC) charge output of the charging device and the second electrical contact is configured to engage a second plug contact corresponding to a negative direct current (DC) charge output of the charging device. Some embodiments provide that the third electrical contact is configured to engage a third plug contact corresponding to an electrical ground and the fourth electrical contact is configured to engage a fourth plug contact corresponding to an electrical ground check of the charging device.

In some embodiments, the electrically conductive jumper is connected to the first electrical contact and the second electrical contact on the second side of the non-conductive housing.

Some embodiments provide that the adapter receptacle is configured to operate at voltages around 200 volts DC and the electrical contacts are configured to carry about 350 amperes DC.

Some embodiments disclosed herein are directed to methods of charging a rechargeable mining device. Such methods may include connecting a first charger output plug to a charging receptacle of the rechargeable mining device and connecting a second charger output plug to an adapter receptacle that is configured to cause electrical conductivity between a first pair of multiple electrical contacts in the second charger output plug when connected to the adapter receptacle.

Some embodiments provide that the first pair of the electrical contacts in the second charger plug correspond to a positive direct current (DC) charge output of the charging device and a negative direct current (DC) charge output of the charging device. In some embodiments, connecting the second charger output plug to the adapter receptacle causes electrical conductivity between a second pair of the electrical contacts in the second charger plug. Some embodiments provide that the second pair of the electrical contacts in the second charger plug correspond a ground and a ground check of the charging device.

Further features, advantages and details of the present invention will be appreciated by those of ordinary skill in the art from a reading of the figures and the detailed description of the preferred embodiments that follow, such description being merely illustrative of the present invention.

It is noted that aspects of the invention described with respect to one embodiment, may be incorporated in a different embodiment although not specifically described relative thereto. That is, all embodiments and/or features of any embodiment can be combined in any way and/or combination. These and other objects and/or aspects of the present invention are explained in detail in the specification set forth below,

### BRIEF DESCRIPTION OF THE DRAWINGS

The accompanying figures are included to provide a further understanding of the present invention, and are incorporated in and constitute a part of this specification. The drawings illustrate some embodiments of the present invention and, together with the description, serve to explain principles of the present invention.

FIGS. 1a and 1b are block diagrams illustrating conventional charging circuits and rechargeable equipment having two batteries and one battery, respectively.

FIG. 2 is a block diagram illustrating a system for charging rechargeable equipment having two batteries and one battery according to some embodiments of the present invention.

FIG. 3 is a schematic diagram illustrating charging systems, methods and devices used for charging rechargeable equipment having two batteries according to some embodiments of the present invention.

FIG. 4 is a schematic diagram illustrating charging systems, methods and devices used for charging rechargeable equipment having one battery according to some embodiments of the present invention.

FIGS. 5a and 5b are schematic front and rear views of an adapter receptacle according to some embodiments of the present invention.

FIG, 6a and 6b are schematic front and cutaway side views of an adapter receptacle and housing according to some embodiments of the present invention.

FIG. 7 is a block diagram illustrating operations corresponding to systems, methods and apparatus for mining equipment charging according to some embodiments of the present invention.

### DETAILED DESCRIPTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

As used herein the expression “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

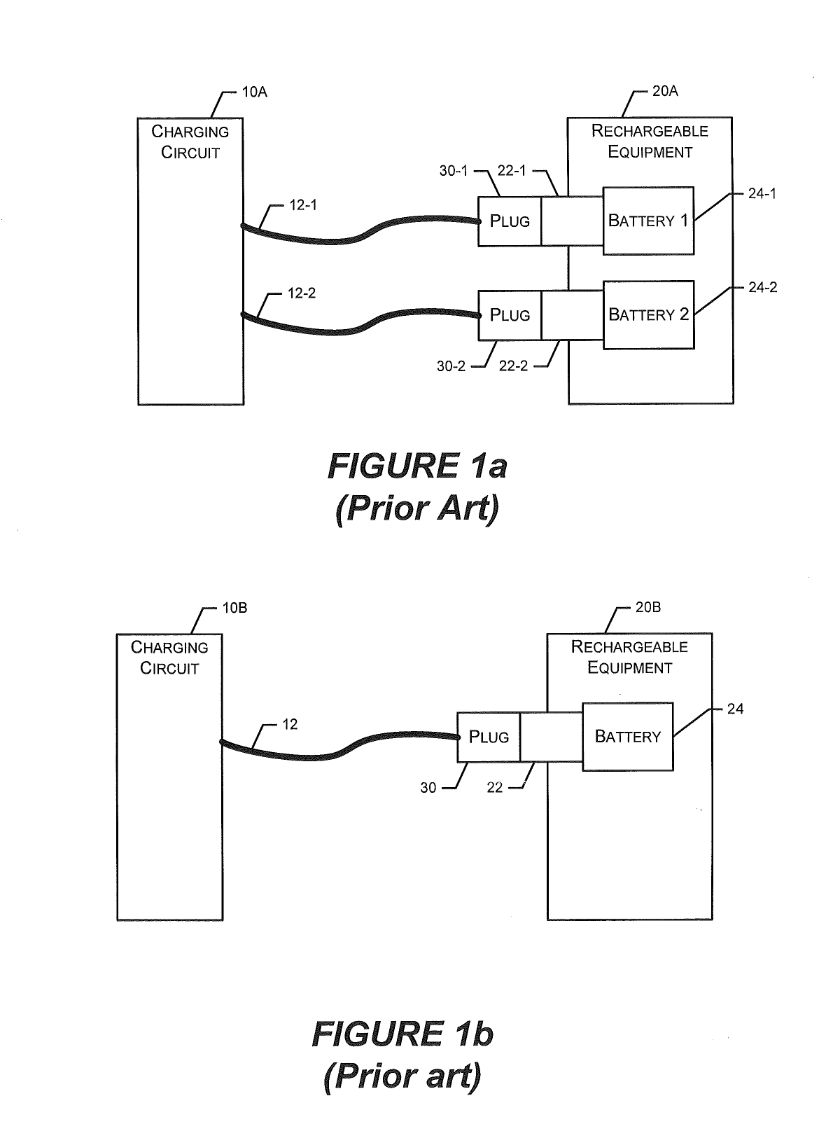

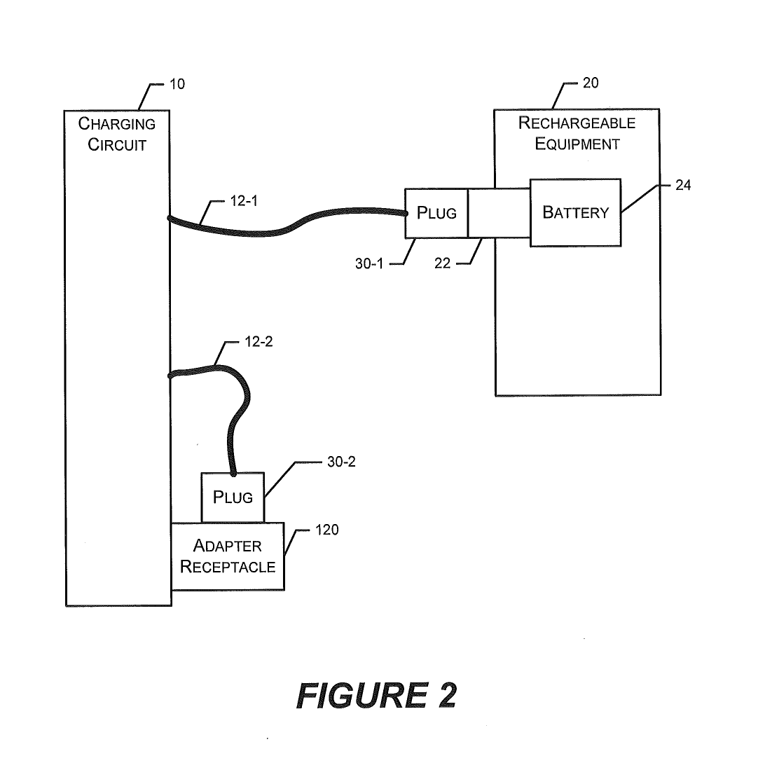

Reference is now made to FIG. 2 is a block diagram illustrating a system for charging rechargeable equipment having two batteries and one battery according to some embodiments of the present invention. As illustrated, the system may include a charging circuit 10 that is operable to provide an electrical charging current to rechargeable equipment 20. The charging circuit 10 may be operable to charge rechargeable equipment including two batteries 24 as discussed above regarding FIG. 1A. For example, the charging circuit 10 is coupled to two charger output plugs 30-1 and 30-1 via cables 12-1 and 12-2, respectively. Some embodiments provide that the cables 12-1 and 12-2 may each be multiple conductor cables configured to conduct currents corresponding to charging and/or monitoring charge conditions.

Embodiments as described herein may also be operable to charge rechargeable equipment 20 that includes only a single battery 24 that is conductively coupled to a single charging receptacle 22. The charging receptacle 22 may be configured to receive a charging current from the charging circuit 10 via the charger output plug 30-1. Embodiments described herein may include an adapter receptacle 120 that is configured to receive the second charger output plug 30-2 when the rechargeable equipment 20 includes only a single charging receptacle 22 that is configured to receive the first charger output plug 30-1. The adapter receptacle 120 allows a charging circuit 10 that is operable to charge rechargeable equipment 20A (FIG. 1a) having two batteries 24-1 and 24-2 (FIG. 1a) via charger output plugs 30-1 and 30-2 to also charge rechargeable equipment 20 having a single battery 24 via the first charger output plug 30-1 without modifying charging circuit 10.

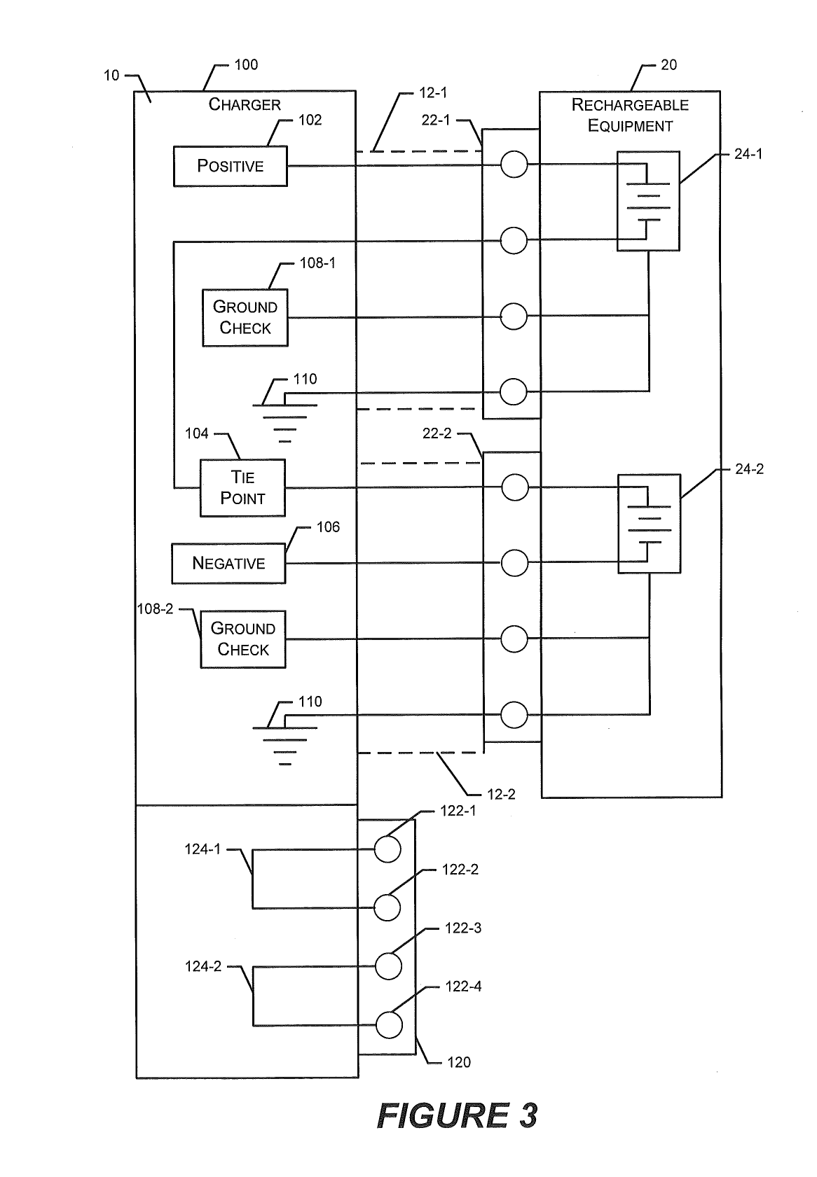

Reference is now made to FIG. 3, which is a schematic diagram illustrating charging systems, methods and devices used for charging rechargeable equipment having two batteries according to some embodiments of the present invention. A charger 100 may be coupled to rechargeable equipment 20 via multiple conductive paths in, for example, cables 12-1 and 12-2. The multiple conductive paths may be received at the rechargeable equipment 20 via charging receptacles 22-1 and 22-2 that correspond to batteries 24-1 and 24-2, respectively. Although not illustrated in the present figure, embodiments described may also include charger output plugs (FIG. 2, 30-1, 30-2) that are configured to be received by the charging receptacles 22-1 and 22-2. The charger 100 may include a charging circuit 10 that provides a positive terminal 102 that is configured to provide a positive direct current (DC) charging current to the positive terminal of the first battery 24-1. The negative terminal of the first battery 24-1 is coupled to a tie point 104 in the charger 100.

The tie point 104 in the charger 100 may also be coupled to the positive terminal in the second battery 24-2. A negative terminal 106 in the charger 100 may be coupled to the negative terminal of the second battery 24-2. In this manner, the first and second batteries may be charged via a charging current that flows from the positive terminal 102 through the first battery 24-1, the tie point 104 and the second battery 24-2 to the negative terminal 106. Additionally, each of the first and second batteries 24-1 and 24-2 may have a ground 110 and a ground check 108-1 and 108-2.

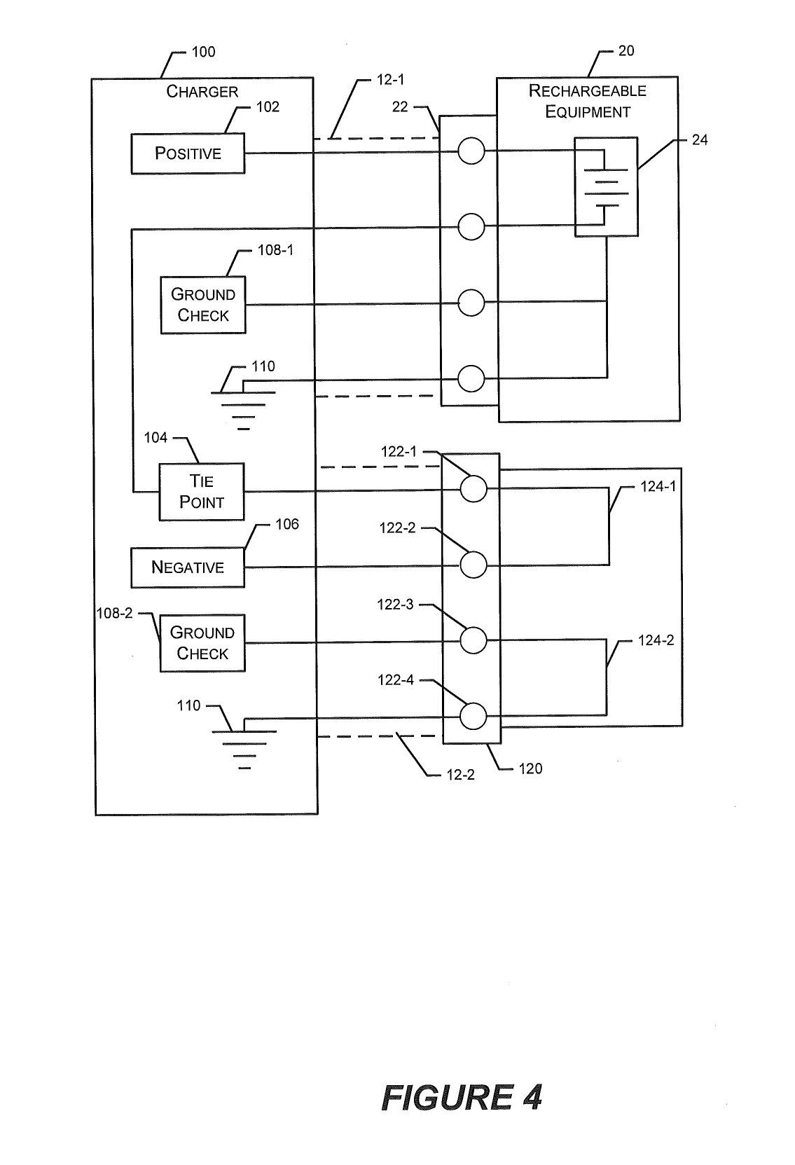

In use and operation, when charging rechargeable equipment 20 having two batteries 24-1 and 24-2, the adapter receptacle 120 may not receive a charger output plug 30-1 and 30-2 (FIG. 2). However, in the circumstance that the rechargeable equipment 20 only includes a single battery 24 and charging receptacle 22, then the adapter receptacle may be configured to receive one of the charger output plugs 30-2 that may be attached to the charger 100 via cable 12-2. For example, reference is now made to FIG. 4, which is a schematic diagram illustrating charging systems, methods and devices used for charging rechargeable equipment having one battery according to some embodiments of the present invention.

The connection of the charger 100 to the battery 24 of the rechargeable equipment 20 is substantially the same as the connection of the charger 100 to the first battery 24-1 as discussed above regarding FIG. 3 and thus will not be repeated. The second cable 12-2 that may include a second charger output plug (30-2, FIG. 2) may be connected to the adapter receptacle 120. Some embodiments provide that the adapter receptacle 120 is a separate device from the charger 100. However, in some embodiments, the adapter receptacle 120 may be integrated into and or mounted on or near the charger 100.

When connected to the adapter receptacle 120, the tie point 104 may be conductively coupled to the negative terminal 106 via a conductive jumper 124-1. In this manner, the charging current may flow from the positive terminal 102, through the first battery 24, the tie point 104 and the conductive jumper 124-1 to the negative terminal 106. In this manner, the charger 100 may be operable to charge either dual battery rechargeable equipment or single battery rechargeable equipment without modification thereto.

In some embodiments, chargers 100 as discussed herein may be used with mining equipment or devices that operate using rechargeable batteries. For example, some rechargeable equipment 20 may include two batteries 24 that each include 32 cells and provide about 64 volts DC. In the alternative, some rechargeable equipment 20 may include one battery 24 that includes 64 cells and provides about 128 volts DC. A charger 100 used in conjunction with and adapter receptacle as disclosed herein may function to charge either the single battery equipment or the dual battery equipment.

The adapter receptacle 120 may include a conductive jumper 124-2 that is configured to conductively couple the ground check terminal 108-2 to the ground 110. In some embodiments, the adapter receptacle 120 may include electrical contacts 122 that may conductively engage electrical contacts in a charger output plug 30-2. For example, electrical contact 122-1 may correspond to a positive charging current terminal, electrical contact 122-2 may correspond to a negative charging current terminal, electrical contact 122-3 may correspond to a ground check terminal, and electrical contact 122-4 may correspond to the ground terminal.

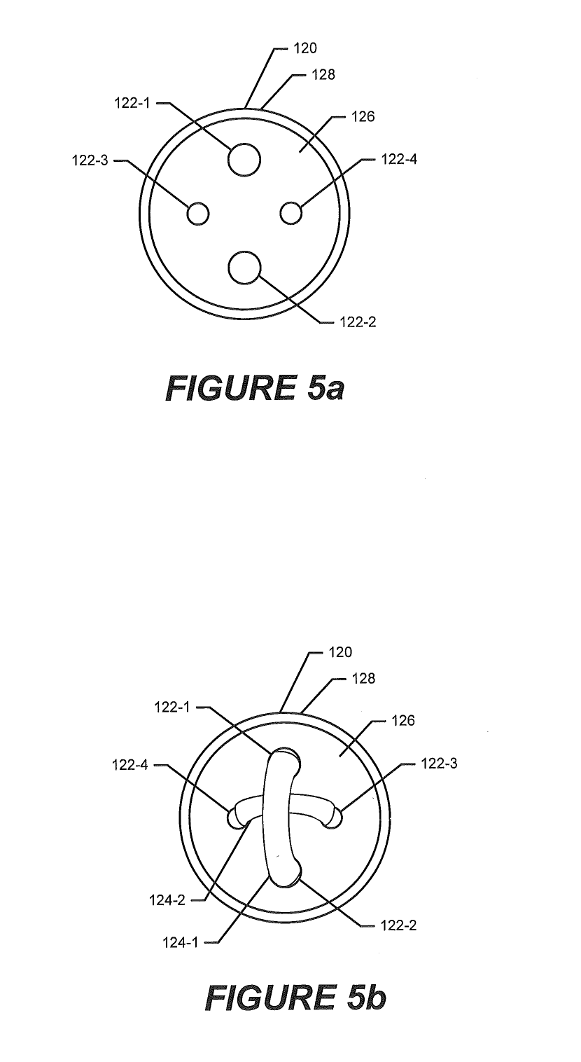

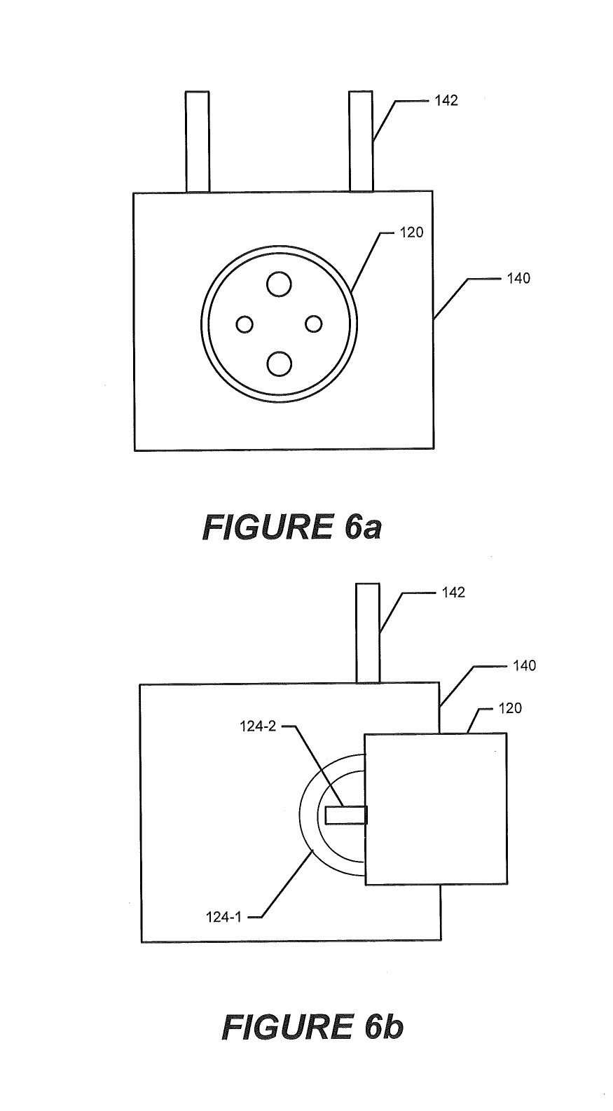

Reference is now made to FIGS. 5a and 5b, which are schematic front and rear views of an adapter receptacle 120 according to some embodiments of the present invention. As illustrated, the adapter receptacle 120 may include electrical contacts 122 arranged in a non-conductive housing 126 that may be further mounted in an outer housing 128. In some embodiments, a retention structure (not illustrated) may be included either in the adapter receptacle, the charger output plug 30 and/or the combination thereof. For example, the charger output plug may be secured to the adapter receptacle via a threaded engagement or other type of mechanical retention mechanism. In some embodiments, the retention mechanism may be incorporated into the electrical contacts 122, such as in a twist locking arrangement. Although illustrated as including four electrical 122 contacts, embodiments of the invention are not so limited. For example, the adapter receptacle may include more or less than four electrical contacts 122.

As discussed above regarding FIG. 4, the electrical contacts 122-1 through 122-4 may correspond to a positive terminal, a negative terminal, a ground check terminal and a ground terminal, respectively. Although illustrated as having a circular cross-sectional shape, the electrical contacts 122 are not so limited. For example, one or more of the electrical contacts 122 may include a blade, box, and/or L-shaped cross-sectional shape, among others. Additionally, the electrical contacts 122 of the adapter receptacle 120 may be pins, sockets and/or a combination thereof.

Referring to FIG. 5a, the front side of the adapter receptacle 120 may include the portion of the electrical contacts 122 that are configured to engage a charger output plug 30. Referring to FIG. 5b, the opposite side of the adapter receptacle 120 may include portions of the electrical contacts 122 and/or the jumper 124 that are configured to connect different ones of the electrical contacts 122 to one another. For example, some embodiments provide that conductive jumper 124-1 is configured to create electrical continuity between electrical contacts 122-1 and 122-2, which may be the positive and negative terminals. In some embodiments, conductive jumper 124-2 is configured to create electrical continuity between electrical contacts 122-3 and 122-4, which may be the ground check and ground terminals.

Some embodiments provide additional structural support for the adapter receptacle 120. For example, brief reference is made to FIGS. 6a and 6b, which are schematic front and cutaway side views of an adapter receptacle and housing according to some embodiments of the present invention. Referring to FIG. 6a, the adapter receptacle 120 may be supported by and/or mounted in and/or to a housing 140. The housing 140 may include one or more mounting provisions for receiving the adapter receptacle 120, including, for example, holes for mounting hardware such as screws, bolts and/or rivets, among others. The housing 140 may include mounting structures 142 that may engage, temporarily and/or permanently, a structure on which the housing 140 is to be mounted. For example, some embodiments provide that the housing 140 and adapter receptacle 120 may be attached to and/or mounted on a charger and/or other proximate structure.

Briefly referring to FIG. 6b, the housing may include a cavity that shields, conceals, protects and/or otherwise contains the rear of the adapter receptacle 120 and the conductive jumpers 124. Some embodiments provide that the conductive jumpers 124 may include insulated cables, however, this is merely exemplary. For example, the conductive jumpers 124 may be integral to the adapter receptacle 120 and may be contained within the adapter receptacle housing 126.

In some embodiments, the adapter receptacle 120 is configured to operate in DC voltages up to about 200 volts, but the invention is not so limited. For example, an adapter receptacle 120 may be configured to operate at 500 Volts, 1 kVolt, or 5 kVolts, among others. Some embodiments provide that the electrical contacts 122 and/or the conductive jumpers 124 are configured to carry about 200 amperes, however the invention is not so limited. For example, electrical contacts 122 and/or conductive jumpers 124 may be configured to carry 300 amperes, 350 amperes, 400 amperes and/or 500 amperes, among others.

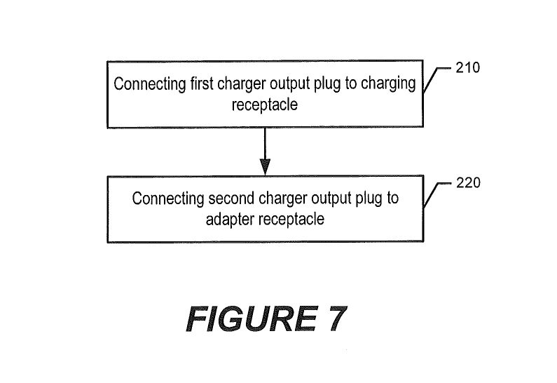

Reference is now made to FIG. 7, which is a block diagram illustrating operations corresponding to systems, methods and apparatus for mining equipment charging according to some embodiments of the present invention. In some embodiments, methods of charging a rechargeable mining device may include connecting a first charger output plug to a charging receptacle of the rechargeable mining device (block 210). Methods may further include connecting a second charger output plug to an adapter receptacle that is configured to cause electrical conductivity between a first pair of electrical contacts in the second charger output plug when connected to the adapter receptacle (block 220). Some embodiments provide that the first pair of the electrical contacts in the second charger plug correspond a positive direct current (DC) charge output of the charging device and a negative direct current (DC) charge output of the charging device.

In some embodiments, connecting the second charger output plug to the adapter receptacle is further configured to cause electrical conductivity between a second pair of the electrical contacts in the second charger plug. Some embodiments provide that the second pair of electrical contacts in the second charger plug correspond a ground and a ground check of the charging device.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

What is claimed is:

1. A charging device adapter comprising:
an adapter receptacle that is positioned proximate a charging device that is configured to charge a rechargeable device and that includes a plurality of charger output plugs that are conductively coupled to a charging circuit, the adapter receptacle configured to receive one of the plurality of charger output plugs when the rechargeable device includes a quantity of charging receptacles that is less than a quantity of the plurality of charger output plugs.

2. The charging device adapter according to claim 1, further comprising an adapter housing that is configured to be mounted to the charging device and that is configured to receive and support the adapter receptacle.

3. The charging device adapter according to claim 1,
wherein the plurality of charger output plugs comprises a first charger output plug and a second charger output plug,
wherein the quantity charging receptacles on the rechargeable device is one charging receptacle,
wherein the one charging receptacle is configured to receive the first charger output plug, and
wherein the adapter receptacle is configured to receive the second charger output plug.

4. The charging device adapter according to claim 1, wherein the adapter receptacle comprises:
a plurality of electrical contacts arranged in a non-conductive housing, the non-conductive housing including a first side that is configured to receive the one of the plurality of charger output plugs and a second side that is opposite the first side; and
an electrically conductive jumper that is connected to a first electrical contact and a second electrical contact of the plurality of electrical contacts to cause an electrical short circuit across the first electrical contact and the second electrical contact.

5. The charging device adapter according to claim 4,
wherein the electrically conductive jumper comprises a first electrically conductive jumper, and
wherein the adapter receptacle further comprises a second electrically conductive jumper that is connected to a third electrical contact and a fourth electrical contact of the plurality of electrical contacts to cause an electrical short circuit across the third electrical contact and the fourth electrical contact.

6. The charging device adapter according to claim 5,
wherein the first electrical contact is configured to engage a first plug contact corresponding to a positive direct current (DC) charge output of the charging device, and
wherein the second electrical contact is configured to engage a second plug contact corresponding to a negative direct current (DC) charge output of the charging device.

7. The charging device adapter according to claim 6,
wherein the third electrical contact is configured to engage a third plug contact corresponding to an electrical ground, and
wherein the fourth electrical contact is configured to engage a fourth plug contact corresponding to an electrical ground check of the charging device.

8. The charging device adapter according to claim 4, wherein the electrically conductive jumper is connected to the first electrical contact and the second electrical contact on the second side of the non-conductive housing.

9. The charging device adapter according to claim 1, wherein the rechargeable device comprises mining equipment.

10. The charging device adapter according to claim 1, wherein the adapter receptacle is configured to operate at a voltage around 200 volts DC and the electrical contacts are configured to carry about 350 amperes DC.

11. A configurable charging system, the system comprising:
a charging circuit that is configured to provide an electrical charging current to a rechargeable mining device;
a first charger output plug that is conductively coupled to the charging circuit via a first multiple conductor cable;
a second charger output plug that is conductively coupled to the charging circuit via a second multiple conductor cable; and
an adapter receptacle that is configured to receive the second charger output plug when the rechargeable mining device includes a single charging receptacle that is configured to receive the first charger output plug,
wherein when the rechargeable mining device includes two charging receptacles, the two charging receptacles are configured to receive the first charger output plug and the second charger output plug.

12. The charging system according to claim 11, wherein the adapter receptacle comprises:
a plurality of electrical contacts arranged in a non-conductive housing, the non-conductive housing including a first side that is configured to receive the second charger output plug and a second side that is opposite the first side; and
an electrically conductive jumper that is connected to a first electrical contact and a second electrical contact of the plurality of electrical contacts to cause an electrical short circuit across the first electrical contact and the second electrical contact.

13. The charging system according to claim 12,
wherein the electrically conductive jumper comprises a first electrically conductive jumper, and
wherein the adapter receptacle further comprises a second electrically conductive jumper that is connected to a third electrical contact and a fourth electrical contact of the plurality of electrical contacts to cause an electrical short circuit across the third electrical contact and the fourth electrical contact.

14. The charging system according to claim 13,
wherein the first electrical contact is configured to engage a first plug contact corresponding to a positive direct current (DC) charge output of the charging device, and
wherein the second electrical contact is configured to engage a second plug contact corresponding to a negative direct current (DC) charge output of the charging device.

15. The charging system according to claim 14,
wherein the third electrical contact is configured to engage a third plug contact corresponding to an electrical ground, and
wherein the fourth electrical contact is configured to engage a fourth plug contact corresponding to an electrical ground check of the charging device.

16. The charging system according to claim 12, wherein the electrically conductive jumper is connected to the first electrical contact and the second electrical contact on the second side of the non-conductive housing.

17. The charging system according to claim 11, wherein the adapter receptacle is configured to operate at a voltage around 200 volts DC and the electrical contacts are configured to carry about 350 amperes DC.

18. A method of charging a rechargeable mining device, the method comprising:
connecting a first charger output plug to a charging receptacle of the rechargeable mining device;
connecting a second charger output plug to an adapter receptacle that is configured to cause electrical conductivity between a first pair of a plurality of electrical contacts in the second charger output plug when connected to the adapter receptacle.

19. The method according to claim 18, wherein the first pair of the plurality of electrical contacts in the second charger plug correspond to a positive direct current (DC) charge output of the charging device and a negative direct current (DC) charge output of the charging device.

20. The method according to claim 19, wherein connecting the second charger output plug to the adapter receptacle is further configured to cause electrical conductivity between a second pair of the plurality of electrical contacts in the second charger plug.

21. The method according to claim 20, wherein the second pair of the plurality of electrical contacts in the second charger plug correspond a ground and a ground check of the charging device.
